(19) United States
(12) Patent Application Publication
(10) Pub. No.: US 2006/0192750 A1
(43) Pub. Date: Aug. 31, 2006

(54) Liquid crystal display and method for adjusting temperature thereof

(75) Inventor: Ching-Kun Lai, Dacun Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/177,164

(22) Filed: Jul. 8, 2005

(30) Foreign Application Priority Data
Feb. 25, 2005 (TW) 94105956

(51) Int. Cl. G09G 3/36

(52) U.S. Cl. 345/102

(57) ABSTRACT

A liquid crystal display (LCD) includes a backlight module and a heat dissipation device. The backlight module includes a frame, a reflector and several light sources. The reflector is disposed on the frame. The light sources disposed above the reflector. The heat dissipation device includes a fan, a sensor and a controller. The sensor is for sensing internal temperature of the LCD. The controller is connected to the fan and is for controlling the rotating speed of the fan according to the internal temperature of the LCD.

This application claims the benefit of Taiwan application Serial No. 94105956, filed Feb. 25, 2005, the subject matter of which is incorporated herein by reference.

### BACKGROUND OF THE INVENTION

1. Field of the Invention

The invention relates in general to a liquid crystal display (LCD), and more particularly to an LCD with a heat dissipation device and a method for adjusting temperature of the LCD.

2. Description of the Related Art

Because of the rapid advance of the technology of manufacturing the liquid crystal display (LCD) and the LCD has the advantages of light, thin, power-saving and radiationless properties, the LCDs are widely used in various electrical products, such as PDAs (Personal Digital Assistants), notebook computers, digital cameras, digital camcorders, mobile telephones, computer monitors and liquid crystal televisions. However, because the LCD panel in the LCD is a display panel that cannot emit light itself, a backlight module has to provide light so that the display function can be achieved. The conventional backlight module includes a frame, a reflector and several cold cathode fluorescent lamps (CCFLs). The reflector is disposed on the frame, and the CCFLs are disposed above the reflector to provide light.

Because the CCFL generates heat to cause a high temperature rise while emitting light, the conventional LCD adopts the heat dissipating mechanism of natural convection. However, as the required brightness of the LCD is gradually increasing, the increased brightness of the CCFL inevitably generates more heat, and the internal environmental temperature of the LCD is thus increased. Because the working environmental temperature of the CCFL is increased, the light emitting quality of the CCFL is deteriorated. In addition, if the working environmental temperature of the CCFL is decreased, the light emitting quality of the CCFL is also deteriorated. Similarly, the backlight module using light emitting diodes (LEDs) to provide light also encounters the above-mentioned problems.

### SUMMARY OF THE INVENTION

It is therefore an object of the invention to provide an LCD and a method for adjusting temperature thereof. The method controls the rotating speed of the fan and the current passing through the light sources according to the sensed internal temperature of the LCD so as to help the LCD dissipate heat by increasing the rotating speed of the fan as well as to increase the output heat of the light sources by increasing the values of the currents of the light sources. Thus, the internal environmental temperature of the LCD is adjusted to fall within the best working environmental temperature of the light source such that the light source keeps the good light emitting quality.

The invention achieves the above-identified object by providing a heat dissipation device for a liquid crystal display (LCD). The heat dissipation device includes a fan, a sensor and a controller. The sensor is for sensing internal temperature of the LCD. The controller is connected to the fan and is for controlling the rotating speed of the fan according to the internal temperature of the LCD.

The invention achieves the above-identified object by providing a liquid crystal display (LCD) including a backlight module and a heat dissipation device. The backlight module includes a frame, a reflector and several light sources. The reflector is disposed on the frame. The light sources are disposed above the reflector. The heat dissipation device includes a fan, a sensor and a controller. The sensor is for sensing internal temperature of the LCD. The controller is connected to the fan and is for controlling the rotating speed of the fan according to the internal temperature of the LCD.

The invention achieves the above-identified object by providing a method for adjusting temperature of a liquid crystal display (LCD), which comprises a fan. In the method, firstly, internal temperature of the LCD is sensed. Then, the rotating speed of the fan is controlled according to the internal temperature of the LCD.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a block diagram showing a partial circuit of an LCD according to a first embodiment of the invention.

FIG. 1B is a cross-sectional view showing a partial structure of the LCD according to the first embodiment of the present invention.

FIG. 2 is a schematic illustration showing a rotating speed look-up table according to the first embodiment of the present invention.

FIG. 3 is a flow chart showing a method for adjusting temperature of an LCD according to a second embodiment of the present invention.

FIG. 4 is a flow chart showing a fan controlling step of FIG. 3.

FIG. 5 is a flow chart showing a current controlling step of FIG. 3.

### DETAILED DESCRIPTION OF THE INVENTION

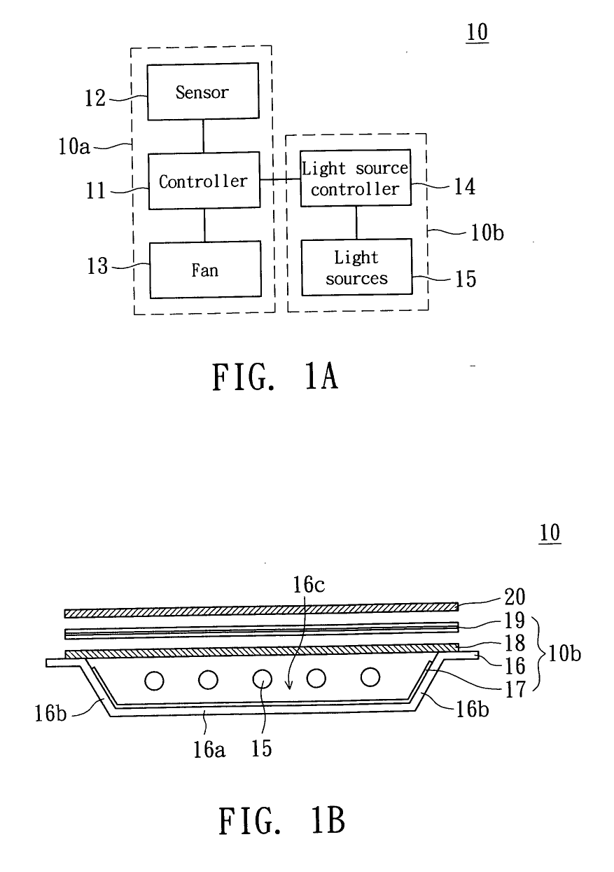

FIG. 1A is a block diagram showing a partial circuit of an LCD according to a first embodiment of the invention. FIG. 1B is a cross-sectional view showing a partial structure of the LCD according to the first embodiment of the invention. Referring to FIGS. 1A and 1B, the liquid crystal display (LCD) 10 includes a heat dissipation device 10a, a backlight module 10b and an LCD panel 20.

The backlight module 10b includes a frame 16, a reflector 17, several light sources 15, a diffuser 18, an optical film set 19 and a light source controller 14. In this embodiment, the frame 16 has a base 16a and a sloped side plate 16b, both of which define a cavity 16c with an upward opening. The reflector 17 is located in the cavity 16c and disposed on the base 16a and the sloped side plate 16b. The light sources 15, which include several cold cathode fluorescent lamps (CCFLs), several external electrode fluorescent lamps (EEFLs) or several light emitting diodes (LEDs), are located in the cavity 16c and disposed above the reflector 17. In this example, the light sources 15 include several CCFLs.

The diffuser 18 is disposed on the frame 16 and above the light sources 15 to seal the opening of the cavity 16c. The optical film set 19 is disposed above the diffuser 18 and includes diffusing sheets and prism sheets. In addition, the LCD panel 20 is disposed above the optical film set 19, and the light source controller 14 is electrically connected to the light sources 15.

The heat dissipation device 10a includes a fan 13, a sensor 12 and a controller 11. The sensor 12 is for sensing internal temperature T of the LCD 10. In this embodiment, the sensor 12 is configured to sense the internal temperature of the frame 16, the reflector 17, or the light sources 15. In addition, the controller 11 is electrically connected to the fan 13 and is for controlling the rotating speed of the fan 13 according to the internal temperature T of the LCD 10. Moreover, the light source controller 14 is electrically connected to the controller 11 and the light sources 15. The light source controller 14 is for controlling current passing through the light sources 15 according to the internal temperature T of the LCD 10.

When the controller 11 is controlling the rotating speed of the fan 13, the LCD 10 has a first default value X1, and the controller 11 compares the internal temperature T of the LCD 10 with the first default value X1 to determine whether or not the internal temperature T of the LCD 10 is higher than the first default value X1.

When the controller 11 has determined that the internal temperature T of the LCD 10 is higher than the first default value X1 and the controller 11 finds that the fan 13 is rotating at a first rotating speed R1, it means that the internal environmental temperature of the LCD 10 is too high or exceeds the maximum value of the best working environmental temperature of the light sources 15, and the light emitting quality of the light sources 15 tends to be deteriorated. In order to keep the good light emitting quality of the light sources 15 continuously, the controller 11 changes the rotating speed of the fan 13 from the first rotating speed R1 to a second rotating speed R2, which is higher than the first rotating speed R1. Consequently, increasing the rotating speed of the fan 13 can help the LCD 10 dissipate heat and prevent the internal environmental temperature of the LCD 10 from exceeding the maximum value of the best working environmental temperature of the light sources 15, such that the light sources 15 can be kept at the good light emitting quality.

When the controller 11 has determined that the internal temperature T of the LCD 10 is lower than or equal to the first default value X1 and the controller 11 finds that the fan 13 is rotating at the first rotating speed R1, it means that the internal environmental temperature of the LCD 10 falls within the range of the best working environmental temperature of the light sources 15. At this time, the controller 11 keeps the rotating speed of the fan 13 being at the first rotating speed R1.

When the light source controller 14 is controlling the current passing through the light sources 15, the LCD 10 has a second default value X2, and the light source controller 14 compares the internal temperature T of the LCD 10 with the second default value X2 to determine whether or not the internal temperature T of the LCD 10 is lower than the second default value X2.

When the light source controller 14 finds that the internal temperature T of the LCD 10 is lower than the second default value X2 and the current passing through the light sources 15 equals a first current Cl, it means that the internal environmental temperature of the LCD 10 is too low or lower than the minimum value of the best working environmental temperature of the light sources 15. In this case, the light emitting quality of the light sources 15 is also deteriorated. In order to keep the good light emitting quality of the light sources 15, the light source controller 14 changes the currents passing through the light sources 15 from the first current C1 to a second current C2, which is higher than the first current C1. In this embodiment, the second current C2 value is substantially twice as much as the first current C1 value. Because the light sources 15 is a heat source, the output heat of the light sources 15 can be increased by increasing the current passing through the light sources 15. Hence, the internal environmental temperature of the LCD 10 can be increased to keep the internal environmental temperature of the LCD 10 below the minimum value of the best working environmental temperature of the light sources 15, such that the good light emitting quality of the light sources 15 is kept.

When the light source controller 14 has determined that the internal temperature T of the LCD 10 is higher than or equal to the second default value X2 and the current passing through the light sources 15 equals the first current C1, it means that the internal environmental temperature of the LCD 10 falls within the range of the best working environmental temperature of the light sources 15. At this time, the light source controller 14 only has to keep the current passing through the light sources 15 being at the first current C1 without changing the current passing through the light sources 15.

In addition, the first default value X1 and the second default value X2 have to be configured according to the position of the sensor 12 and the to-be-sensed object. When the sensor 12 senses the tube wall temperature of the light sources 15 and the best working environmental temperature of the CCFL light sources 15 ranges from 25° C. to 70° C., it means that the maximum value and the minimum value of the best working environmental temperature of the light sources 15 are 70° C. and 25° C., and the first default value X1 and the second default value X2 may be set as 70° C. and 25° C., respectively. The first default value X1 and the second default value X2 may be stored in a storage unit, such as a memory, electrically connected to the controller 11 and the light source controller 14 in the LCD 10.

In this embodiment, the controller 11 can grade the parameters for controlling the fan according to the extent by which the internal temperature T of the LCD 10 exceeds the first default value X1. As the extent by which the internal temperature T of the LCD 10 exceeds the first default value X1 gets larger, the controller 11 adjusts the rotating speed of the fan to a higher rotating speed. For example, the LCD 10 includes a rotating speed look-up table, which has N temperature zones and N default rotating speeds corresponding to the N temperature zones, wherein N is a positive integer. When the controller 11 finds that the internal temperature T of the LCD 10 falls within the j-th temperature zone, the controller 11 looks up the j-th default rotating speed corresponding to the j-th temperature zone according to the rotating speed look-up table, and changes the rotating speed of the fan 13 from the first rotating speed R1 to the j-th default rotating speed (i.e., the second rotating speed R2), wherein j is an integer ranging from 1 to N. The controller 11 changes the rotating speed of the fan 13 from the first rotating speed to the second rotating speed higher than the first rotating speed according to a rotating speed look-up table when the internal temperature T of the LCD 10 is higher than the first default value.

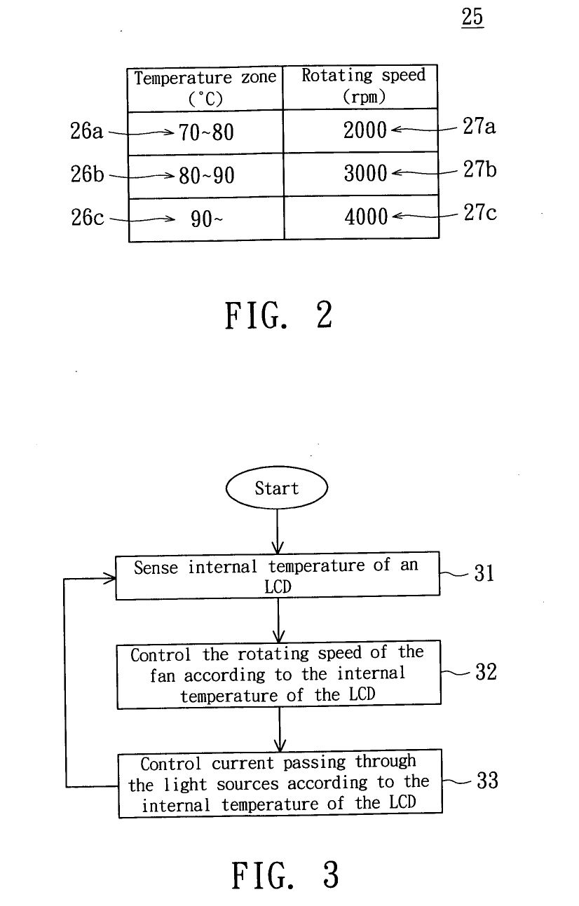

FIG. 2 is a schematic illustration showing a rotating speed look-up table according to the first embodiment of the invention. As shown in FIG. 2, the rotating speed look-up table 25 has, for example, three temperature zones and three default rotating speeds corresponding to the zones. When the controller 11 finds that the internal temperature T of the LCD 10 is higher than 70° C. but lower than 80° C. so that the internal temperature T of the LCD 10 falls within the first temperature zone 26a, the controller 11 changes the rotating speed of the fan 13 from the first rotating speed R1 to the first rotating speed 27a (i.e., 2000 rpm). When the controller 11 finds that the internal temperature T of the LCD 10 is higher than 80° C. but lower than 90° C. so that the internal temperature T of the LCD 10 falls within the second temperature zone 26b, the controller 11 changes the rotating speed of the fan 13 from the first rotating speed R1 to the second rotating speed 27b (i.e., 3000 rpm). When the controller 11 finds that the internal temperature T of the LCD 10 is higher than 90° C. so that the internal temperature T of the LCD 10 falls within the third temperature zone 26c, the controller 11 changes the rotating speed of the fan 13 from the first rotating speed R1 to the third rotating speed 27c (i.e., 4000 rpm). The first rotating speed R1 may be 0 rpm, which means that the fan 13 is stationary.

One of ordinary skill in the art may easily understand that the present embodiment of the invention technology is not limited thereto. For example, the controller 11 and the light source controller 14 may be integrated into a whole. In addition, the light source controller 14 may be electrically connected to the sensor 12 directly without being electrically connected to the controller 11.

FIG. 3 is a flow chart showing a method for adjusting temperature of the LCD according to a second embodiment of the invention. As shown in FIGS. 3, 1A and 1B, the method of this embodiment is used in an LCD 10, which includes a fan 13. First, as shown in step 31, sense internal temperature T of the LCD 10. The LCD 10 further includes a backlight module 10b, which includes a frame 16, a reflector 17 and several light sources 15. In step 31, it is also possible to sense the internal temperature T of the frame 16, the reflector 17, or the light sources 15.

Next, the procedure enters step 32 to control the rotating speed of the fan 13 according to the internal temperature T of the LCD 10. Then, the procedure enters step 33 to control current passing through the light sources 15 according to the internal temperature T of the LCD 10. Next, the procedure goes back to step 31 to continue to monitor the temperature of the LCD 10 so as to adjust the temperature of the LCD 10.

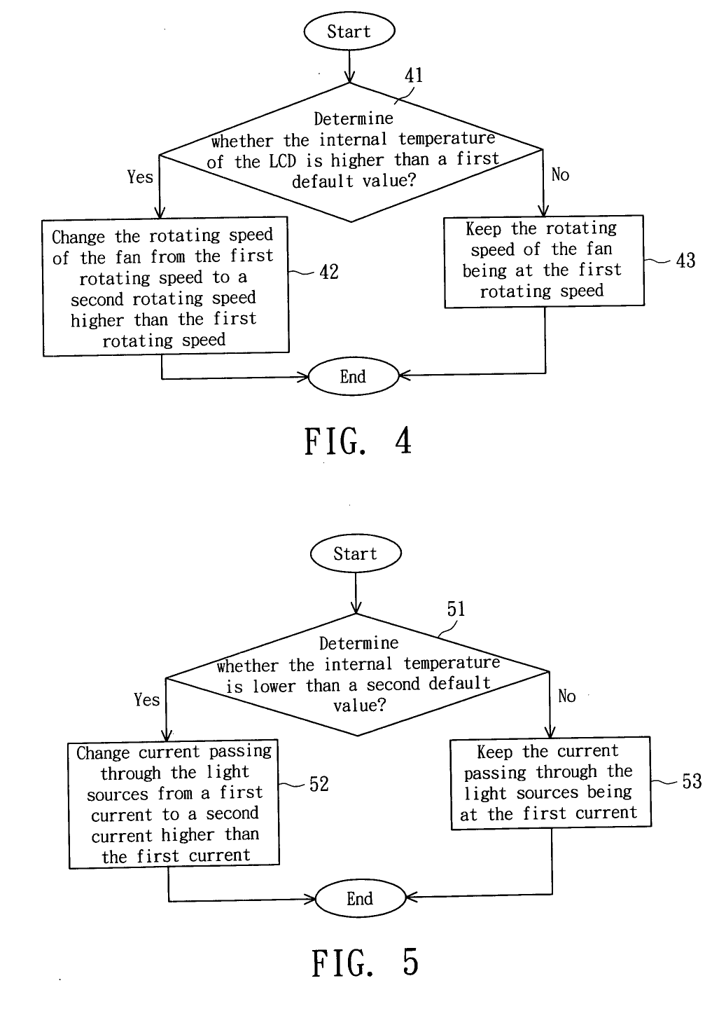

As shown in FIG. 4, the above-mentioned step 32 further includes the following sub-steps. First, in step 41, compare the internal temperature T of the LCD 10 with a first default value X1 to determining whether or not the internal temperature T of the LCD 10 is higher than the first default value X1. When the internal temperature T of the LCD 10 is higher than the first default value X1 and the fan 13 is rotating at a first rotating speed R1, the procedure enters step 42 to change the rotating speed of the fan 13 from the first rotating speed R1 to a second rotating speed R2 higher than the first rotating speed R1. Then, the procedure enters the step 33 of FIG. 3. When the internal temperature T of the LCD 10 is lower than or equal to the first default value X1 and the fan 13 is rotating at the first rotating speed R1, the procedure enters step 43 to keep the rotating speed of the fan 13 being at the original rotating speed (i.e., the first rotating speed R1). Then, the procedure enters the step 33 of FIG. 3.

This embodiment can grade the parameters for controlling the fan 13 according to the extent by which the internal temperature T of the LCD 10 exceeds the first default value X1. As the extent by which the internal temperature T of the LCD 10 exceeds the first default value X1 gets larger, a controller 11 adjusts the rotating speed of the fan to a higher rotating speed. For example, the LCD 10 further includes a rotating speed look-up table, which has N temperature zones and N default rotating speeds corresponding to the N temperature zones, wherein N is a positive integer. In the step of changing the rotating speed of the fan 13 from the first rotating speed R1 to the second rotating speed R2 higher than the first rotating speed R1, when the internal temperature T of the LCD 10 falls within the j-th temperature zone, the j-th default rotating speed corresponding to the j-th temperature zone is looked up according to the rotating speed look-up table, and the rotating speed of the fan 13 is changed from the first rotating speed to the j-th default rotating speed, wherein j is an integer ranging from 1 to N. The above-mentioned first rotating speed may be 0 rpm, which means that the fan 13 is stationary.

As shown in FIG. 5, step 33 further includes the following sub-steps. First, in step 51, compare the internal temperature T of the LCD 11 with a second default value X2 to determined whether or not the internal temperature T of the LCD 11 is lower than the second default value X2. When the internal temperature T of the LCD 11 is lower than the second default value X2 and the current passing through the light sources 15 equal a first current C1, the procedure enters step 52 to change the current passing through the light sources 15 from the first current C1 to a second current C2 higher than the first current C1. Then, the procedure enters the step 31 of FIG. 3. The second current C2 value is substantially twice as much as the first current C1 value. When the internal temperature T of the LCD 11 is higher than or equal to the second default value X2 and the current passing through the light sources 15 equal the first current C1, the procedure enters step 53 to keep the current passing through the light sources 15 being at the original current (i.e., the first current C1). Then, the procedure enters the step 31 of FIG. 3.

One of ordinary skill in the art may easily understand that the present embodiment of the invention technology is not limited thereto. For example, this present embodiment of the invention can firstly perform the step 33 and then the step 32. In addition, this present embodiment of the invention may also perform the step 32 and the step 33 simultaneously. In addition, the step 33 can be omitted from this embodiment, and only the step 31 and the step 32 are performed. Of course, the step 32 may be omitted from this embodiment, and only the step 31 and the step 33 are performed.

In the LCD and the method for adjusting temperature thereof according to the embodiments of the invention, the rotating speed of the fan and the current passing through the light sources are controlled according to the sensed internal temperature of the LCD. The present embodiment of the invention can help the LCD to dissipate heat by increasing the rotating speed of the fan so as to decrease the internal environmental temperature of the LCD. In addition, the invention may further increase the output heat of the light sources by increasing the current passing through the light sources so as to increase the internal environmental temperature of the LCD. Consequently, this present embodiment of the invention may adjust the internal environmental temperature of the LCD by controlling the rotating speed of the fan and the current passing through the light sources, such that the internal environmental temperature of the LCD falls within the range of the best working environmental temperature of the light source and the good light emitting qualities of the light sources may be kept.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A heat dissipation device for a liquid crystal display (LCD), comprising:
a fan;
a sensor for sensing internal temperature of the LCD; and
a controller, connected to the fan, for controlling the rotating speed of the fan according to the internal temperature of the LCD.

2. A liquid crystal display (LCD), comprising:
a backlight module, comprising:
a frame;
a reflector disposed on the frame; and
a plurality of light sources disposed above the reflector; and
a heat dissipation device, disposed adjacent to the backlight module, comprising:
a fan;
a sensor for sensing internal temperature of the LCD; and
a controller, connected to the fan, for controlling the rotating speed of the fan according to the internal temperature of the LCD.

3. The LCD according to claim 2, wherein the backlight module further comprises:
a light source controller, connected to the light sources, for controlling current passing through the light sources according to the internal temperature of the LCD.

4. The LCD according to claim 3, wherein the controller and the light source controller are integrated into a whole.

5. The LCD according to claim 2, wherein the sensor is configured to sense the temperature of the frame, the reflector or the light sources.

6. The LCD according to claim 2, wherein the light sources comprise a plurality of cold cathode fluorescent lamps (CCFLs), a plurality of external electrode fluorescent lamps (EEFLs) or a plurality of light emitting diodes (LEDs).

7. A method for adjusting temperature of a liquid crystal display comprising a fan, comprising:
sensing internal temperature of the LCD; and
controlling the rotating speed of the fan according to the internal temperature of the LCD.

8. The method according to claim 7, wherein controlling the rotating speed of the fan comprises:
comparing the internal temperature of the LCD with a first default value;
changing the rotating speed of the fan from a first rotating speed to a second rotating speed higher than the first rotating speed when the internal temperature of the LCD is higher than the first default value; and
keeping the rotating speed of the fan being at the first rotating speed when the internal temperature of the LCD is lower than or equal to the first default value.

9. The method according to claim 8, wherein changing the rotating speed of the fan from the first rotating speed to the second rotating speed comprises:
changing the rotating speed of the fan from the first rotating speed to the second rotating speed higher than the first rotating speed according to a rotating speed look-up table when the internal temperature of the LCD is higher than the first default value.

10. The method according to claim 9, wherein the first rotating speed is 0 rpm.

11. The method according to claim 8, wherein the first rotating speed is 0 rpm.

12. The method according to claim 8, wherein the LCD further comprises a backlight module having a frame, a reflector disposed on the frame. and a plurality of light sources disposed above the reflector, and wherein sensing the internal temperature of the LCD comprises:
sensing the temperature of the frame, the reflector or the light sources.

13. The method according to claim 12, further comprising:
controlling current passing through the light sources according to the internal temperature of the LCD.

14. The method according to claim 13, wherein controlling the current comprises:
comparing the internal temperature of the LCD with a second default value;
changing the current through the light sources from a first current value to a second current value higher than the first current value when the internal temperature of the LCD is lower than the second default value; and
keeping the current through the light sources being at the first current value when the internal temperature of the LCD is higher than or equal to the second default value.

15. The method according to claim 14, wherein the second current value is substantially twice as much as the first current value.

16. The method according to claim 7, wherein the LCD further comprises a backlight module having a frame, a reflector disposed on the frame and a plurality of light sources disposed above the reflector, and wherein sensing the internal temperature of the LCD comprises:
sensing the temperature of the frame, the reflector or the light sources.

17. The method according to claim 16, further comprising:
controlling current passing through the light sources according to the internal temperature of the LCD.

18. The method according to claim 17, wherein controlling the current comprises:
comparing the internal temperature of the LCD with a first default value;
changing the current through the light sources from a first current value to a second current value higher than the first current value, when the internal temperature of the LCD is lower than the first default value; and
keeping the current through the light sources being at the first current value, when the internal temperature of the LCD is higher than or equal to the first default value.

19. The method according to claim 18, wherein the second current value is substantially twice as much as the first current value.
